(19) United States
(12) Patent Application Publication
(10) Pub. No.: US 2015/0186363 A1
(43) Pub. Date: Jul. 2, 2015

(54) Search-Powered Language Usage Checks

(71) Applicant: Adobe Systems Incorporated, San Jose, CA (US)

(72) Inventor: Samartha Vashishtha, Noida (IN)

(73) Assignee: Adobe Systems Incorporated, San Jose, CA (US)

(21) Appl. No.: 14/141,862

(22) Filed: Dec. 27, 2013

(51) Int. Cl. G06F 17/30; G06F 17/27

(52) U.S. Cl. CPC G06F 17/30011; G06F 17/2705; G06F 17/30864

(57) ABSTRACT

Techniques for a search-powered language usage service are described in which existing collections of documents are employed as sources of correct usage. A service may operate to search documents from the Internet or other document sources to produce a usage database of “correct” usage phrases that spans different languages, styles, and other contexts. Metadata associated with phrases added to the database may be used to understand the context of usage and perform usage checks using filtered, context-specific phrases for particular languages, dialects, geographic regions, styles, custom scenarios, and so forth. In one approach, separate databases for different contexts may be derived from data maintained in a global database. The service may expose the usage database(s) to enable applications to analyze target documents by comparing phrases to correct usage phrases and perform responsive actions to facilitate correct usage in various ways.

### BACKGROUND

Today, individuals frequently use word processors, text editors, and other applications to create and edit text based documents, articles, emails, and other work product. Some programs may provide tools such as spelling and grammar checkers that operate to assist user in the drafting process. Existing tools for spelling and grammar checks are often rule-based systems that rely upon a set of static rules. Such systems require considerable effort to produce and maintain the set of rules and this effort may be repeated for multiple languages and style guides. Further, these rule-based systems may not adequately capture idiomatic usage and style. Because the rule-based systems typically employ static rules, revising the rules and deploying new rules may be complicated and the rules may lag behind ever evolving language usage.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Techniques for search-powered language usage checks are described herein. In one or more implementations, existing collections of documents are employed as sources of correct usage. For instance, a service may be configured to search documents available from the Internet and other document sources to produce a usage database of phrases designated as “correct” usage. This may involve, analyzing the documents to extract constituent phrases and sub-phrases to add to the usage database. The usage database may be configured as a global database that spans different languages, styles, and other contexts. Metadata associated with phrases added to the database may be used to understand the context of usage and perform usage checks using filtered, context-specific phrases. Thus, usage checks may employ context-specific sub-sets of the global database for particular languages, dialects, geographic, regions, styles, custom scenarios, industry domains, vertical markets, and so forth. In one approach, separate databases for different languages, styles, and contexts may be derived from data collected in the global database. The service may expose the usage database(s) to enable applications to analyze target documents by comparing phrases to correct usage phrases in the usage database and perform responsive actions to facilitate correct usage in various ways.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is a flow diagram depicting an example procedure to build a usage database in accordance with one or more implementations.

FIG. 3 is flow diagram depicting an example procedure to extract usage phrases from source documents in accordance with one or more implementations.

FIG. 4 is a diagram depicting an example representation of extracting usage phrases from source text in accordance with one or more implementations.

FIG. 5 is a flow diagram depicting an example procedure to perform usage checks in accordance with one or more implementations.

FIG. 6 is a diagram depicting an example scenario in which example actions are performed responsive to usage checks in accordance with one or more implementations.

FIG. 7 is a diagram depicting another example in which example actions are performed responsive to usage checks in accordance with one or more implementations.

FIG. 8 illustrates an example system including various components of an example device that can be employed for one or more implementations of customized log-in experiences described herein.

### DETAILED DESCRIPTION

### Overview

Existing tools for spelling and grammar checks are often rule-based systems that rely upon a set of static rules. To check spelling and grammar using a rule-based system, a checker tool compares terms and phrases in a document against a fixed database of language rules that are pre-defined for each language. For instance, rules for grammar, style, syntax, and sentence construction may be manually programmed and tested on training data. Rule creation for rule-based systems is a tedious process that requires considerable effort to form rules for each language and does not account for actual usage. Additionally, rule-based systems lack flexibility to adapt quickly to constant changes in language usage since rules must be redefined whenever a change occurs to reflect the change in the rules.

Techniques for a search-powered language usage checks are described herein that rely upon known good sources of style and grammar to derive a database of designated “correct” usage phrases. For instance, a service may be configured to search documents available from multiple trusted web domains on the Internet or other document libraries that are considered examples of correct usage. The service may operate to analyze documents from one or multiple selected sources to extract constituent phrases and sub-phrases and add to the extracted phrases to a usage database. The service may also collect and store metadata that is indicative of contextual usage of the phrases in association with the phrases. The checking therefore relies upon know examples of correct usage rather than on a fixed set of language rules.

In an implementation, the usage database is configured as a global database that spans different languages, styles, and other contexts. The metadata associated with phrases added to the database may be used to understand the context of usage and selectively perform usage checks using filtered, context-specific phrases. Thus, usage checks may employ context-specific sub-sets of the global database for particular languages, dialects, geographic, regions, styles, custom scenarios, industry domains, vertical markets, and so forth. In one approach, separate databases for different languages, styles, and contexts may be derived from data collected in the global database. In addition or alternatively, a usage database may be filtered on-demand when a usage check is performed to obtain a sub-set of context-specific phrases that match a particular context for a target of the usage check.

Additionally, the service may expose the usage database(s) to enable applications to analyze target documents/text by comparing phrases to correct usage phrases in the usage database and perform responsive actions to facilitate correct usage in various ways. Usage checks using search-powered usage databases may be performed to entire documents or selected target text. Further, checks may occur responsive to invocation of a usage checker by a user selection or based on automatic triggers (e.g., automatically check sentence-by-sentence as a user types). By way of example and not limitation, actions to facilitate correct usage may include outputting visual indications of incorrectly or correctly used phrases within a user interface, performing auto-correction of incorrect usage, generating one or more correction candidates to offer a user for incorrect phrases, categorizing analyzed phrases, or exposing metadata regarding usage associated with phrases contained in the analyzed text for review by a user.

In the following discussion, an example environment is first described that may employ the techniques described herein. Example procedures and implementation details are then described which may be performed in the example environment as well as other environments. Consequently, performance of the example procedures and details is not limited to the example environment and the example environment is not limited to performance of the examples procedures and details.

Example Environment

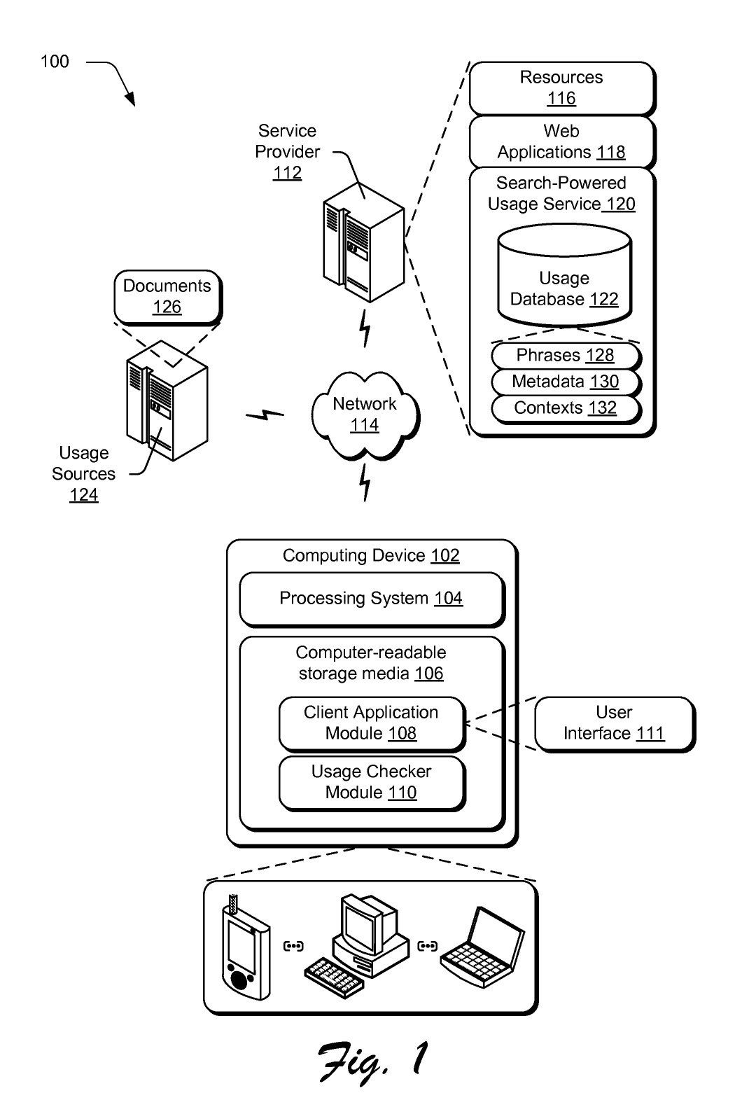

FIG. 1 is an illustration of an environment 100 in an example implementation that is operable to employ techniques described herein. The illustrated environment 100 includes a computing device 102 including a processing system 104 that may include one or more processing devices, one or more computer-readable storage media 106 and a client application module 108 embodied on the computer-readable storage media 106 and operable via the processing system 104 to implement corresponding functionality described herein. In at least some embodiments, the client application module 108 may represent a browser of the computing device operable to access various kinds of web-based resources (e.g., content and services). The client application module 108 may also represent a client-side component having integrated functionality operable to access web-based resources (e.g., a network-enabled application), browse the Internet, interact with online providers, and so forth.

The computing device 102 may also include or make use of a usage checker module 110 that represents functionality operable to implement techniques for usage checks that employ a search-powered usage service as described above and below. For instance, the usage checker module 110 may be operable to access usage databases to perform usage checks on target documents/text. The usage checker module 110 may also operate to perform various actions to facilitate correct usage responsive to usage checks, such as notifying a user regarding correct/incorrect usage, providing correction candidates for incorrect usage, or auto-correcting phrases, to name a few examples. Notifications and other options associated with usage checks may be exposed via a user interface 111 output by a client application module 108 or other application for which the usage checker module 110 is configured to provide functionality for usage checks.

The usage checker module 110 may be implemented as a software module, a hardware device, or using a combination of software, hardware, firmware, fixed logic circuitry, etc. The usage checker module 110 may be implemented as a standalone component of the computing device 102 as illustrated. In addition or alternatively, the usage checker module 110 may be configured as a component of the client application module 108, an operating system, or other device application. For example, the usage checker module 110 may be provided as a plug-in or downloadable script for a browser. The usage checker module 110 may also represent script contained in or otherwise accessible via a webpage, web application, or other resources made available by a service provider.

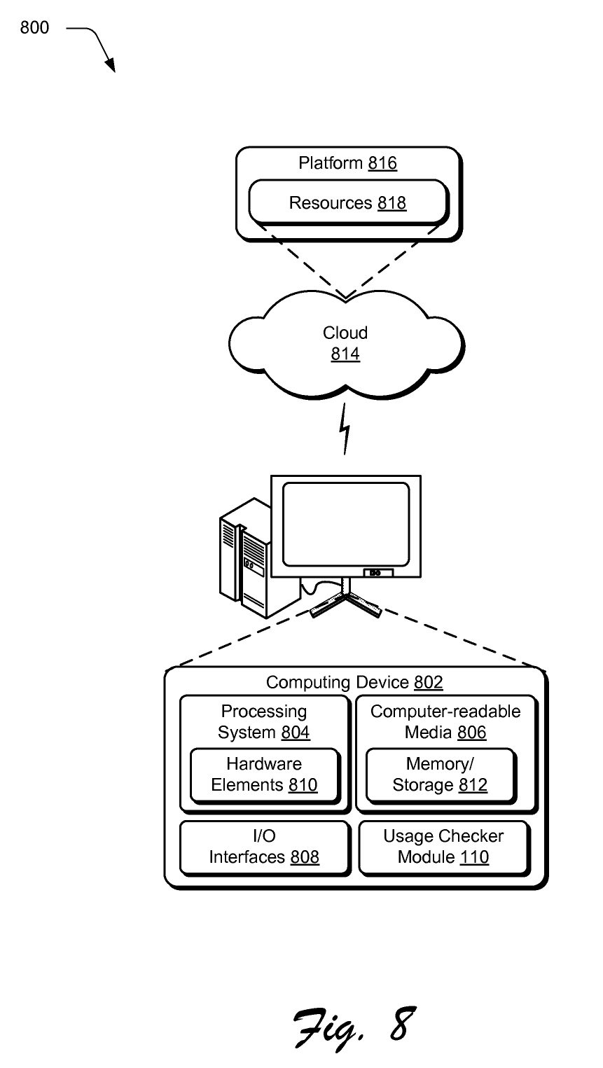

The computing device 102 may be configured as any suitable type of computing device. For example, the computing device may be configured as a desktop computer, a laptop computer, a mobile device (e.g., assuming a handheld configuration such as a tablet or mobile phone), a tablet, and so forth. Thus, the computing device 102 may range from full resource devices with substantial memory and processor resources (e.g., personal computers, game consoles) to a low-resource device with limited memory or processing resources (e.g., mobile devices). Additionally, although a single computing device 102 is shown, the computing device 102 may be representative of a plurality of different devices to perform operations “over the cloud” as further described in relation to FIG. 8.

The environment 100 further depicts one or more service providers 112, configured to communicate with computing device 102 over a network 114, such as the Internet, to provide a “cloud-based” computing environment. Generally, speaking a service provider 112 (e.g., Adobe® Systems, Google™, Apple™, Microsoft™, etc.) is configured to make various resources 116 available over the network 114 to clients. In some scenarios, users may sign-up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services or content typically made available over a network by one or more providers. Some examples of services include, but are not limited to, a photo editing service (e.g., Photoshop®), a web development and management service (e.g., Adobe® Creative Cloud), a collaboration service (e.g., Adobe® Connect™), a social networking service, a messaging service, an advertisement service (e.g., Adobe® Marketing Cloud), and so forth. Content may include various combinations of text, video, ads, audio, multi-media streams, animations, images, web documents, web pages, applications, device applications, and the like.

Web applications 118 represent one particular kind of resource 116 that may be accessible via a service provider 112. Web applications 118 may be operated over a network 114 using a browser or other client application module 108 to obtain and run client-side code for the web application. In at least some implementations, a runtime environment for execution of the web application 118 is provided by the browser (or other client application module 108). Thus, service and content available from the service provider may be accessible as web-applications in some scenarios.

The service provider is further illustrated as including a search-powered usage service 120 that is configured to provide a usage database 122 in accordance with techniques described herein. The search-powered usage service 120 may operate to search different usage sources 124 and analyze documents 126 that are available from the usage sources to produce the usage database 122. The usage database 122 is representative of a server-side repository of data regarding “correct” usage phrases that may be applied to perform usage checks. The search-powered usage service 120, for example, may be configured to provide clients/applications access to utilize the database 122 via respective usage checker modules 110. In addition or alternatively, a usage database 122 may be downloaded to and implemented locally by a computing device in some scenarios.

The usage database 122 may be implemented in various ways to make information regarding “correct” usage phrases accessible to clients/applications. Generally speaking, the database 120 is configured to include phrases 128 and corresponding metadata 130 that describes information regarding contextual usage of the phrases 128. The metadata 130 may include information to associate entries in the database with different languages, styles, categories (e.g., technical field, business, genres, content types, geographic locations) etc., date and time stamps, and other contextual parameters. At least some of the metadata 130 may be derived based on characteristics of the usage sources 124 such as a domain name, URL, location, type of source, owner/company associated with the source, and so on. The metadata 130 may also be extracted from headers, XML data, fields, tags, content, categories, or data contained in/or otherwise associated with documents 126 that are analyzed.

As further represented in FIG. 1, the usage database 122 may also be filtered or otherwise divided according to different contexts 132 based on the metadata 130. As mentioned, different sub-sets of global data in the usage database 122 may be employed for contexts 132 that correspond to particular languages, dialects, geographic, regions, styles, custom scenarios, and so forth. The contexts 132 are representative of separate context-specific databases/versions derived from data collected in the usage database for different contexts. The context-specific versions represented by contexts 132 may be created and maintained persistently as part of the usage database 122 or may be created on-demand for particular scenarios by filtering the data for a given context based on the associated metadata 130. The usage database 122 may be configured as a relational database, object oriented database, a cloud-based database, a distributed database, or other suitable database. The usage database 122 may also represent other forms of data sufficient to describe a library of correct usage phrases such as a table, a data file, navigable file structure, mark-up language document, or other data structure suitable to facilitate look-up of correct usage phrases to check target text against.

Having considered an example environment, consider now a discussion of some example details of techniques for search-powered language usage checks in accordance with one or more implementations.

Search-Powered Language Usage Details

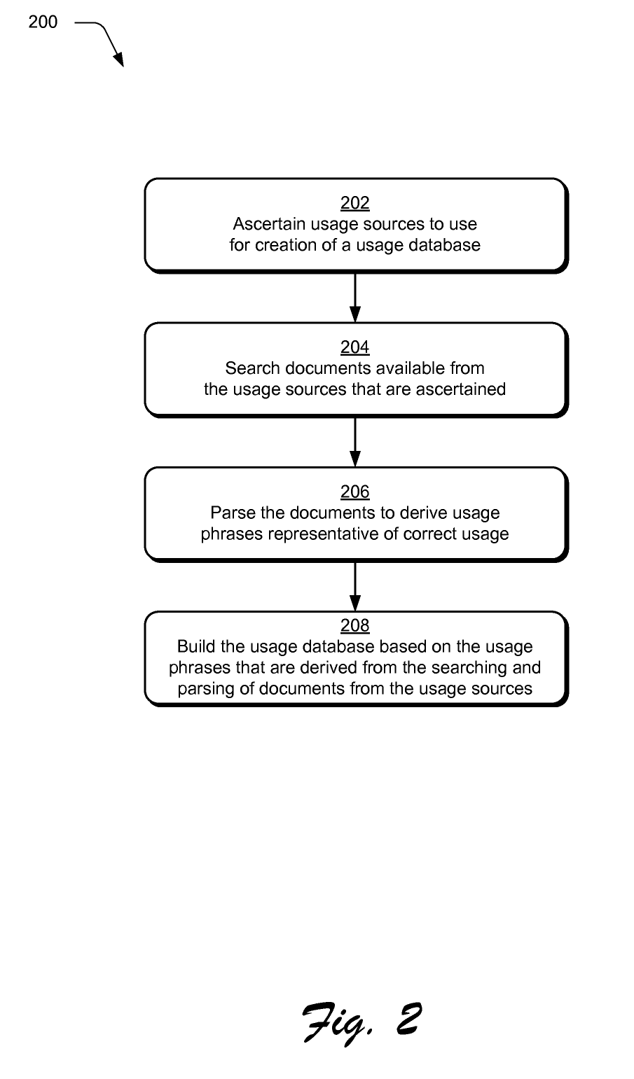

This section describes some example details of search-powered language usage checks in accordance with one or more implementations in relation to some example procedures, scenarios, and user interfaces of FIGS. 2-7. The procedures discussed herein are represented as sets of blocks that specify operations performed by one or more devices and are not necessarily limited to the orders shown for performing the operations by the respective blocks. Aspects of the procedures may be implemented in hardware, firmware, or software, or a combination thereof. Some aspects of the procedures may be implemented via one or more servers, such as via a service provider 112 that maintains and provides access to a usage database 122 via a search-powered usage service 120 or otherwise. Aspects of the procedures may also be performed by a suitably configured device, such as the example computing device 102 of FIG. 1 that includes or makes use of a usage checker module 110 or a client application module 108.

FIG. 2 depicts an example procedure 200 in which a search-powered usage database is built. Usage sources to use for creation of a usage database are ascertain (block 202). As mentioned usage sources 124 may be selected as examples of good language usage. In other words, the usage sources may be considered trusted sources of representative correct phrases. Usage sources 124 may be selected by a developer in a development phase. By way of example and not limitation, the usage sources may include web domains, news entities/sites, education institutions, industry organization and other sources consider representative of correct usage. Generally, the usage sources 124 are network-accessible sources that provide a library of documents 126 that may be searched/crawled to produce a usage database 122. Functionality to enable a user to change the sources between different supported usage providers and select custom sources for usage may also be provided. For example, a company may choose to configure a usage checker system using a collection of company-specific documents that represent custom usage and preferred/custom styles that the company would like employees to use. In another example, a journalism student may want to emulate writing style of a particular news entity and may be able to select the particular news entity from a list of available sources exposed by the system. Thus, a search-powered usage service 120 may support and enable selection of various different usage sources and a usage database 122 may be created using one or multiple selected sources.

Documents available from usage sources that are ascertained are searched (block 204) and the documents are parsed to derive usage phrases representative of correct usage (block 206). Then, the usage database is built based upon the usage phrases that are derived from the searching and parsing of documents from the usage sources (block 208). Generally speaking, the search-powered usage service 120 is configured to analyze documents 126 from one or more designated usage sources 124 to produce a corresponding usage database 122. The search-powered usage service 120 may also be configured to maintain the database by periodically crawling the sources to find new material and update the database accordingly. For example, the database may be updated on a daily, weekly, or monthly basis (or other designated period) to ensure the database reflects relevant usage and adapts over time for evolving style/usage. In order to derive usage phrases, documents from selected sources may be analyzed on a sentence-by-sentence basis to extract constituent phrases and sub-phrases and add them to the database as detailed herein. Instances or counts of commonly encountered phrases may be reflected in the database by using appropriate counter fields in the metadata or by adding separate entries for phrases each time the phrases are encountered. Further examples regarding techniques that may be employed to build a search-powered usage database are described in relation to the following figures.

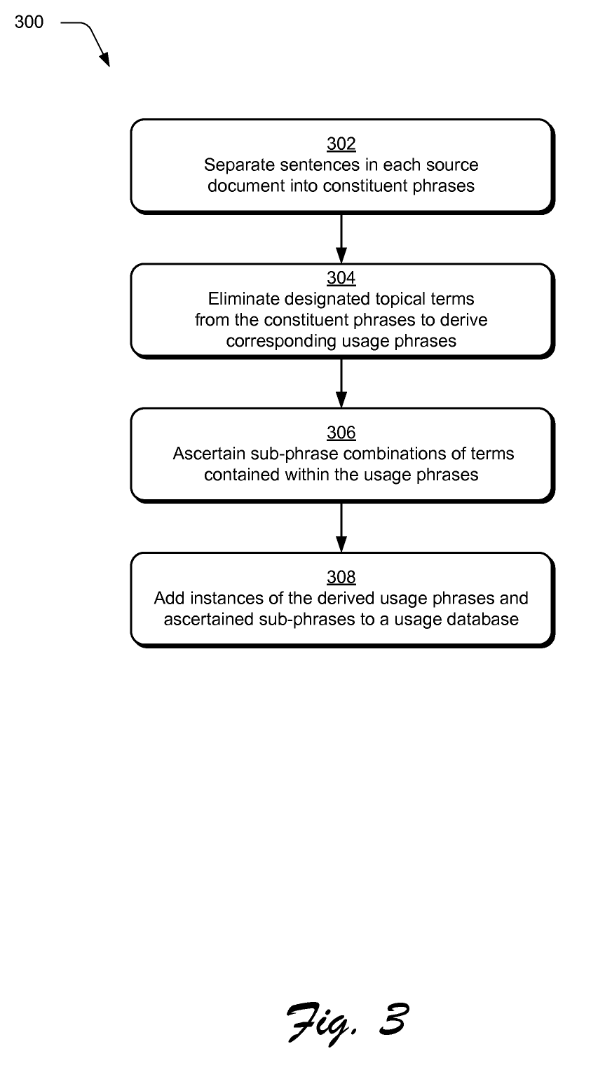

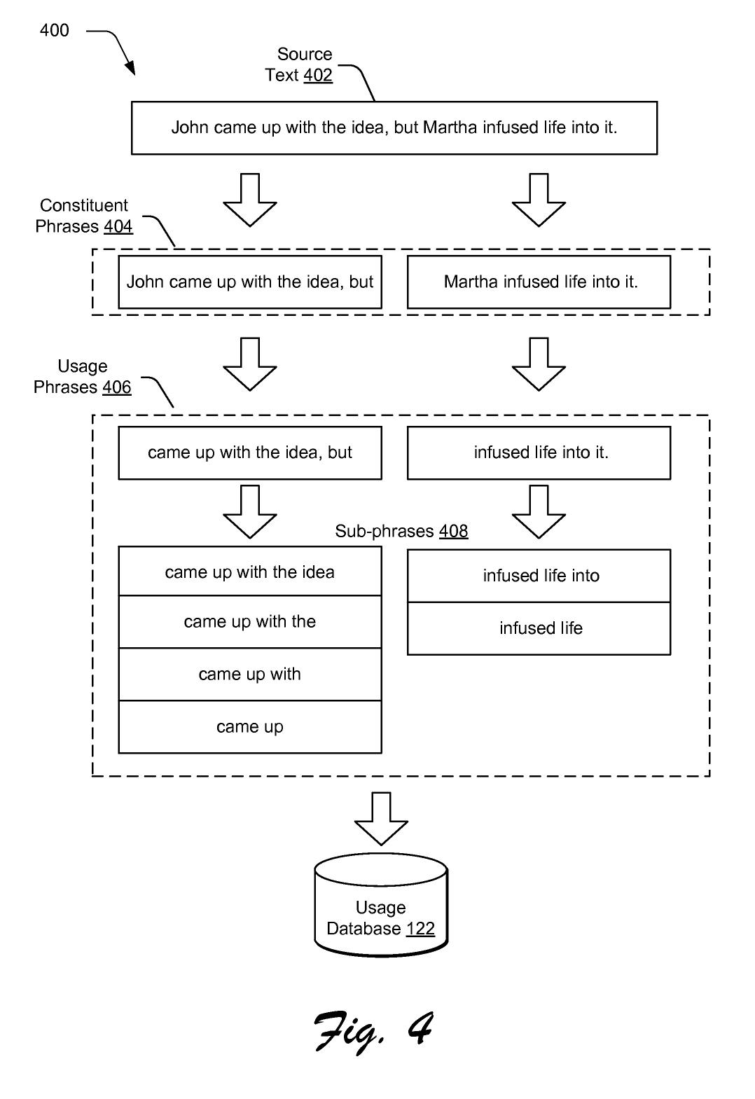

In particular, FIG. 3 depicts an example procedure 300 for analysis of documents from selected usage sources. The procedure may be applied to each individual document included as selected sources for building a usage database, within the context of the example procedure 200 of FIG. 2 or otherwise. The processing may occur by examining the documents on a sentence-by-sentence basis. Naturally, different documents and sources may be processed sequentially or in parallel. In the discussion of the example procedure 300, reference will be made to FIG. 4, which depicts generally at 400 an example scenario in which source text is analyzed to extract usage phrases for inclusion in a usage database.

To generate the database of usage phrases that represent correct usage, sentences in each source document are separated into constituent phrases (block 302). Here, the search-powered usage service 120 operates to recognize constituent phrases and break the sentences up into the constituent parts. In one approach, the search-powered usage service 120 may rely upon delimiters to determine how to break up sentences into phrases. The delimiters may include punctuation marks, breaks/spaces at the beginning and ending of the sentences, and topical terms such as proper names, places, numbers and so forth. In the example of FIG. 4 for instance source text 402 of “John came up with the idea, but Martha infused life into it.” is represented as being broken into constituent phrases 404 of “John came up with the idea, but” and “Martha infused life into it.” The system may recognize these phrases using the proper names John and Martha and the beginning and ending of the sentence as delimiters.

Designated topical terms are eliminated from the constituent phrases to derive corresponding usage phrases (block 304). Additionally, sub-phrase combinations of terms contained within the usage phrases are ascertained (block 306). As noted, topical terms may include named entities, numbers, abbreviations, and other terms that are designated as topical. Removing the topical terms leaves behind grammatical phrases without any topical specificity. FIG. 4 represents creation of usage phrases 406 including “came up with the idea, but” and “infused life into it.” from the constituent phrase 404 by eliminating “John” and “Martha.” Additionally, the usage phrases 406 are each shown as being further divided into sub-phrases 408. The sub-phrases 408 may be obtained by parsing of the usage phrases 406 into different combinations of terms. In one approach, sub-phrases may be created based upon an n-gram parameter. The n-gram parameter may indicate a number of terms to include for sub-phrases 408 at a lowest level of granularity. For example, if the n-gram parameter is set to two then sub-phrases 408 may be produced between the number of terms contained in the constituent phrases 404 (six and four for the example phrases) and bi-gram combinations of those terms. Thus, in the example of FIG. 4, the sub-phrases 408 are illustrated as being divided from starting n-grams of six and four down to bi-grams. In this example, the sub-phrases 408 are produced by sequentially removing terms from the end of the phrases until the lowest level of granularity as indicated by the n-gram parameter is reached. Optionally, additional sub-phrases may be produced by beginning at the beginning term and removing the first term sequentially or by enumerating all possible combinations of the terms in order of the original phrases.

Instances of the derived phrases and ascertained sub-phrases are added to the usage database (block 308). In the example of FIG. 4, the usage phrases 406 and sub-phrases 408 derived therefrom are depicted as being added to the usage database 122. As noted previously, the phrases added in the database may also be associated with various metadata 130. The metadata 130 may be generated to reflect characteristics of the usage sources/documents from which the phrases are derived. For example, usage sources 124 and corresponding documents 126 may be parsed to detect and extract data indicative of characteristics such as a domain name, URL, location, type of source, owner/company associated with the source, languages, writing categories, and so on. Metadata 130 may also include date and time fields that are populated to enable tracking of how recently phrases in the database were added. Thus, a usage database 122 that contains various phrases 128 and corresponding metadata 130 may be produced using techniques described herein. Further, the metadata 130 enables filtering based on combinations of characteristics corresponding to different contexts 132 to create or look-up on-demand context-specific versions of the database for the different 132. The usage database 122 may therefore be applied as a global database of phrases considered “correct” as well as in context-specific scenarios, such as for a particular language, geographic region, a user custom style guide, and so forth.

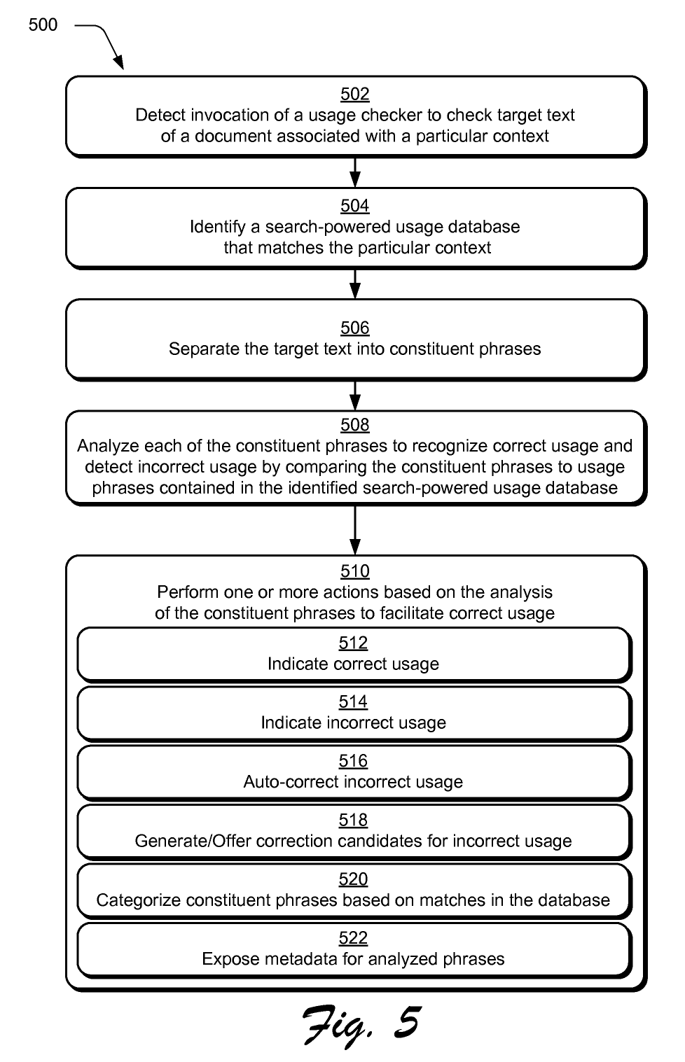

Once created, a usage database 122 may be employed in various ways to check usage in target documents and facilitate the use of correct style by users. Some illustrative details regarding ways in which a usage database 122 may be employed are discussed in relation to an example procedure shown in FIG. 5. In particular, FIG. 5 depicts an example procedure 500 for analysis of target documents/text to check usage and perform appropriate actions responsive to the analysis.

Invocation of a usage checker to check target text of a document associated with a particular context is detected (block 502). For instance, a usage checker module 110 may be invoked in various way to perform usage checks. In an implementation, a user using an application to create/edit a document may make a selection of text in the document and then invoke the usage checker module 110 to perform a check of the selected text. In this case, application of the usage checker module 110 to selected text may be initiated by on-demand user selection of a selectable option, such as a button, menu, toolbar, gesture, shortcut, or other input mechanism supported by the application or a corresponding user interface to launch the checker. In another approach, the usage checker module 110 may be configured to monitor user typing and automatically perform usage checks as the user types. The usage checks may occur on a sentence-by-sentence basis. In yet another approach, the usage checker module 110 may be operable to perform a usage check of an entire document as a whole in response to a user selection to initiate the check or responsive to other triggering events such as automatically checking upon opening or saving of the target document. Invocation of the usage checker in the enumerated ways or otherwise, initiates performance of a usage check upon corresponding target text. The target text may be user selected text or text within an entire document depending upon the particular scenario in which the usage checker is invoked.

In order to perform the usage check, a search-powered usage database that matches the particular context is identified (block 504). Here, the particular context for target text may be ascertained based on metadata associated with the target text. This may occur by analyzing and extracting data indicative of characteristics of the target text in a manner comparable to the way in which context-specific metadata is determined for phrases included in the usage database 122. In addition or alternatively, a user may make selections to specify a context for a particular document that may be used to understand the particular context. A user may do so as part of setting up a document or a document template. In addition or alternatively, the usage checker module 110 may be configured to prompt the user to specify a context or update an existing context data responsive to initiation of a usage check.

If no context information is associated with, specified for, or otherwise available for target text, then the usage checker module 110 may select and apply the usage database 122 on an unfiltered, global basis. When a particular context is determined, however, the usage checker module 110 may operate to locate and obtain a corresponding context-specific version of the usage database 122 to apply for the usage check. This may involve matching of the context determined for the target text with contexts 132 to identify an appropriate context-specific version. In addition or alternatively, the usage checker module 110 may cause filtering of the usage database 122 “on-demand” based on a context determined for the target text to derive a suitable context-specific version of correct phrases to apply in the current scenario.

Having identified an appropriate search-powered usage database, the usage checker module 110 may further operate to perform a usage check upon the target text by searching for matches between phrases in the identified database and phrases in the target texts. To do so, the target text is separated into constituent phrases (506). The separation may involve creating usage phrases and sub-phrases for the target text in a manner comparable to the techniques described previously herein in relation to creation of a usage database 122. Then, each of the constituent phrases is analyzed to recognize correct usage and detect incorrect usage by comparing the constituent phrases to usage phrases contained in the identified search-powered usage database (block 508).

In an implementation, the system may be configured to attempt to match complete phrases of target text first and then proceed to break the constituent phrases down into smaller and smaller sub-phrases until matches are found. Once a match is found for a particular phrase, processing for that particular phrase is concluded and further processing to break the phrase further down may be skipped to avoid unnecessary work. Phrases for which a match is found may be recognized as being associated with correct usage. On the other hand, phrases or portions of phrases for which no matches in the usage database 122 are found may be detected as being associated with incorrect usage.

Thereafter, one or more actions are performed based on the analysis of the constituent phrases to facilitate correct usage (block 510). For instance, analyzing the target text in the described manner enables the system to identify and distinguish between correctly used phrases and incorrectly used phrases. The distinctions between correct and incorrect usage may be employed to drive various responsive actions that may be selectively taken to assist users in recognizing the distinctions to confirm correct usage and to make corrections of incorrect usage.

In general, a variety of responsive actions may be taken based on distinctions between correctly used phrases and incorrectly used phrases. Some particular examples of actions are represented in FIG. 5. For example, actions may include outputting indications to notify a user regarding correct usage (block 512) and incorrect usage (block 514). Indications may be configured and provided in any suitable manner to represent distinctions between correctly used phrases and incorrectly used phrases. In one approach, icons, highlights, graphic identifiers or other indications may be rendered proximate to phrases in a user interface displaying the target text to visually represent the distinctions. In addition or alternatively, a log file that describes the distinctions may be produced based on the analysis. A user may be able to access and view entries in the log file to understand results of the usage check. In yet another example, a separate reviewing pane may be configured to show usage check results in tandem with text displayed in a document viewing/editing pane of an application user interface. In addition, functionality may be provided to selectively toggle display of the indications on or and off such that a viewer may view or hide the indications by operation of a toggle control (e.g., button, menu item, keystroke, etc.).

Additionally, functionality to perform corrections of usage may be provided including auto-correction of incorrect usage (block 516) and generating and offering of correction candidates for incorrect usage (block 518). For instance, the usage checker module 110 may be configured to replace an incorrect phrase automatically with a correct phrase for the database that closely matches the incorrect phrase. The auto-correction feature may be implemented by default or may be configured as a feature that a user may selectively turn on or off for an application or individual documents.

Additionally, the usage checker module 110 may be configured to generate one or more correction candidates for an incorrect phrase based on the analysis. Here, phrases in the database that partially match an incorrect phrase, but do not exactly match the incorrect phrase, may be identified as potential correction candidates. The potential correction candidates may be scored and ranked one to another based on a matching score. Any suitable scoring technique may be used. For example, the matching score may be based upon a number or percentage of terms that match between phrases. Further, the matching score may reflect community usage information regarding corrections/mistakes commonly made by a community of users. A designated number of top ranking correction candidates may then be offered to the user based on the scoring and ranking.

Further, constituent phrases may be categorized based on matches in the database (block 520). The categorization is configured to reflect an indication of the strength of the matches or the frequency of matches for particular phrases. For instance, matches may be categorized on a scale from one to ten (or other relative scale) depending upon the frequency of matches, the closeness of matches, or other designated criteria. Indications regarding phrases may then be selected according to the categorization. In one example, color coded visual clues for phrases may be selectively displayed based on the categorization to enable a viewer to quickly get a sense of the correctness of usage within target text. For example, indicators or text for phrases with no matches may be coded as red, a low number of matches yellow, average matches light green, and high matches dark green. Naturally, different colors and number of categories may be employed. Additionally, different types of visual clues may be employed in combination or in lieu of color coding, such as by using different icons, text styles, highlighting, animations, or other visual clues for different categories.

Moreover, metadata associated with analyzed may be exposed to users (block 522). Here, metadata 130 may be made accessible in conjunction with indications of usage, auto-corrections, predictions and categorization. The metadata 130 may be exposed for target text in a document in various ways. For example, indicators used for correct/incorrect usage or categorizations may be configured as selectable items that are operable to display metadata for a corresponding phrase. Thus, when a user selects, hovers a cursor near, or otherwise interacts with one of the indicators in a designated way, metadata 130 for that item may be displayed. The exposed metadata 130 may indicate a location(s) for matching phrases, date/time of the last match, category/context descriptions, a primary language or dialect description, and other additional information that may be useful to a viewer to understand the results of a usage check.

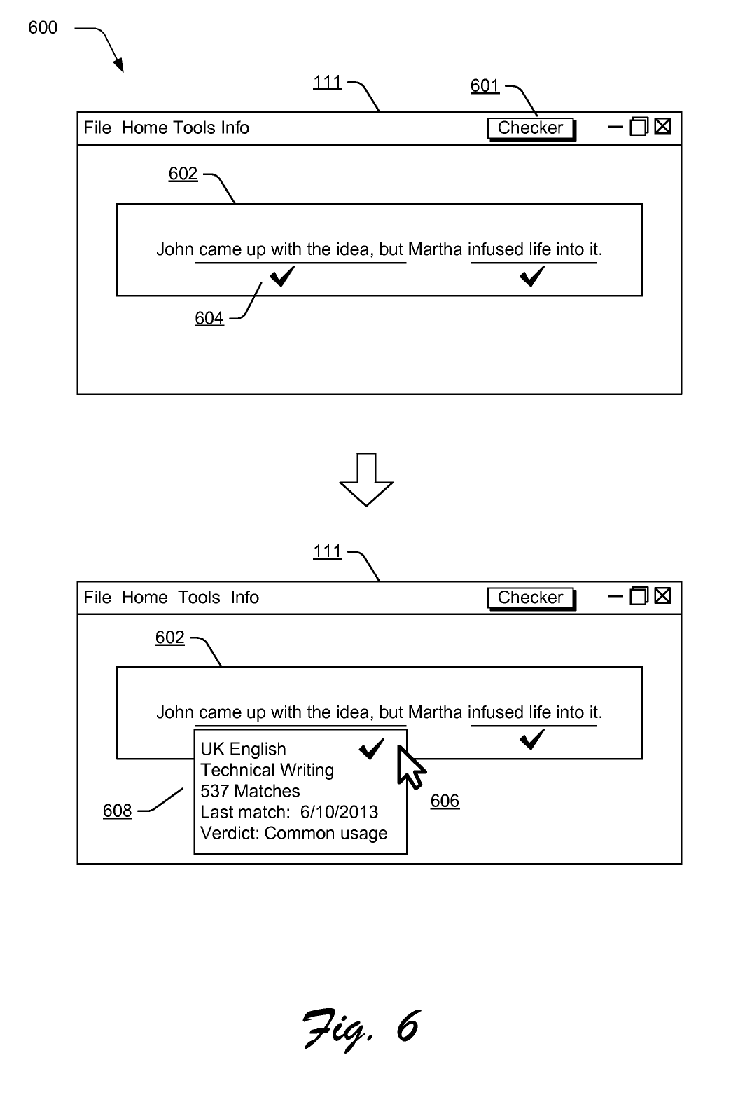

To further illustrate techniques described above, consider now some user interface examples that illustrate some additional aspect of the techniques. For example, FIG. 6 depicts generally at 600 an example scenario in which actions may be taken based on a usage check to facilitate correct usage. In particular, an example user interface 111 for an application is illustrated. The user interface 111 may correspond to a client application module 108, a web application 118, or other application in which a user is viewing, editing, or otherwise manipulating a document. The user interface 111 include a selectable option 601 representative of functionality to invoke a usage checker to perform a usage check on target text 602 as previously described. As mentioned, the usage checker may be invoked responsive to selection of target text 602 and interaction with the selectable option 601 to initiate a check or automatically, such as being triggered sentence-by-sentence responsive to typing by the user. Responsive to initiation of a usage check in one of the enumerated ways or otherwise, the usage check is performed upon the target text 602 and various actions may then be taken as discussed in relation to FIG. 5. In FIG. 6, an example of an indication for correct usage 604 is illustrated. In this example, phrases for the target text 602 are underlined in-line in the document and the indication for correct usage 604 in the form of a checkmark is displayed proximate to each phrase. Other kinds of indications are also contemplated as discussed previously.

FIG. 6 further illustrates an example of selectively displaying metadata 130 associated with the phrases. In particular, the indication for correct usage 604 may be selectable by user to expose corresponding metadata 130. In this example, when a user manipulates a cursor 606 to select or hover near the indication for correct usage 604, a metadata display portion 608 may be exposed in the user interface 111. The metadata display portion 608 may be configured in various ways to represent metadata 130 to the user, such as being a drop-down box (as shown), a pop-out window, a toast message box, and so forth. Here, the metadata that is exposed indicates that the language is UK English, a category is technical writing, 537 matches were found, and the last match was Jun. 10, 2013. A verdict regarding the correctness of use may also be made, which in this case is an indication of common usage.

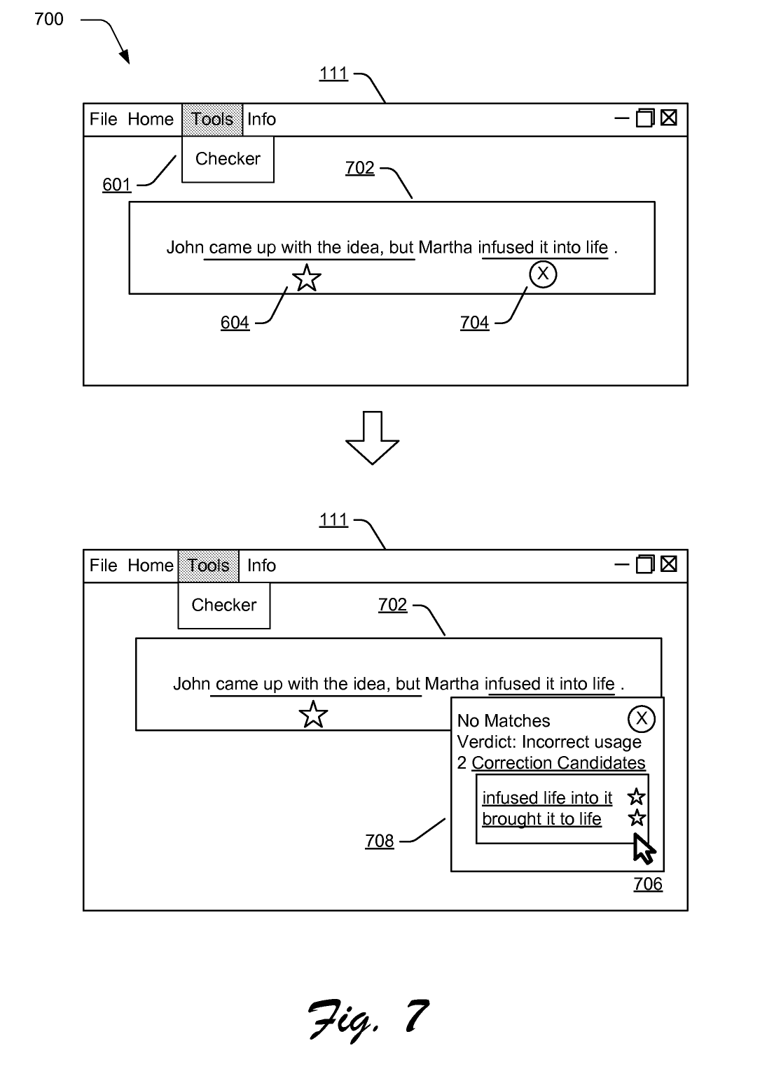

FIG. 7 depicts generally at 700 another example scenario in which actions may be taken based on a usage check to facilitate correct usage. In this example, the user interface 111 depicts a scenario in which target text 702 includes phrases associated with both correct and incorrect usage. Accordingly, an indication for correct usage 604 as noted in relation to FIG. 6 is shown for correct usage and an indication for incorrect usage 704 is shown for correct usage. To illustrate another option for configuration of an indication for correct usage 604, the indication in FIG. 7 is shown as a star icon. The indication for incorrect usage 704 is shown as a different icon, namely an x placed within a circle. Moreover, FIG. 7 also illustrates another option for configuration of the selectable option 601 to invoke the checker, which in this case is depicted as a menu item accessible via tools menu of the user interface 111. Various other examples are also contemplated.

FIG. 7 further illustrates another example of selectively displaying metadata or supplemental information associated with the phrases. In this case, however, the supplemental information is shown in relation to the phrase “infused it into life,” which is detected as being incorrect usage. In this example, when a user manipulates a cursor 706 to select or hover near the indication for incorrect usage 704, a supplemental information portion 708 may be exposed in the user interface 111. The supplemental information portion 708 may be configured in various ways to provide additional information regarding the incorrect phrase to a user. For example, the supplemental information portion 708 may be configured as a drop-down box (as shown), a pop-out window, a toast message box, and so forth. In this example, the supplemental information portion 708 indicates that no matches were found and provides a verdict of incorrect usage. As illustrated, the supplemental information portion 708 may be further configured to present correction candidates for the incorrect phrases. In this case, an indication that correction candidates are available may be presented. The indication may be a selectable control or link that is operable to expose corresponding candidates. In another approach, correction candidates may be shown directly as items in the supplemental information portion 708. Here, phrases “infused life into it” and “brought it to life” are offered as candidates. The candidates may each be selectable to cause replacement of the incorrect phrase with the candidate phrase in the document. As the candidates are considered correct, the indication for correct usage 604 may also be shown along with the candidates as depicted in FIG. 7. Further, the indications shown with correction candidates may be selectable to display corresponding metadata as shown and described in relation to the metadata display portion 608 of FIG. 6.

Having described example procedures and details in accordance with one or more implementations, consider now a discussion of example systems and devices that can be utilized to implement the various techniques described herein.

Example System and Device

FIG. 8 illustrates an example system generally at 800 that includes an example computing device 802 that is representative of one or more computing systems or devices that may implement the various techniques described herein. This is illustrated through inclusion of the usage checker module 110, which operates as described above. The computing device 802 may be, for example, a server of a service provider, a device associated with a client (e.g., a client device), an on-chip system, or any other suitable computing device or computing system.

The example computing device 802 is illustrated as including a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and devices that enable storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and logic embodied on some form of computer-readable storage media and by one or more hardware elements 810. The computing device 802 may be configured to implement particular instructions and functions corresponding to the software and hardware modules. Accordingly, implementation of a module that is executable by the computing device 802 as software may be achieved at least partially in hardware, e.g., through use of computer-readable storage media and hardware elements 810 of the processing system 804. The instructions and functions may be executable/operable by one or more articles of manufacture (for example, one or more computing devices 802 or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes or is representative of a platform 816 for resources 818. The platform 816 abstracts underlying functionality of hardware (e.g., servers) and software resources of the cloud 814. The resources 818 may include applications and data that can be utilized while computer processing is executed on servers that are remote from the computing device 802. Resources 818 can also include services provided over the Internet and through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although techniques have been described in language specific to structural features and methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method implemented by a computing device comprising:
ascertaining usage sources to use for creation of a usage database;
searching documents available from the usage sources that are ascertained;
parsing the documents to derive usage phrases representative of correct usage; and
building the usage database based on the usage phrases that are derived from the searching and parsing of the documents from the usage sources.

2. The method of claim 1, wherein at least one of the usage sources is a network-accessible web domain.

3. The method of claim 1, wherein a least one of the usage sources is a collection of documents representative of a custom style associated with a particular customer.

4. The method of claim 1, further comprising enabling client applications to access the usage database over a network via a service to perform usage checks upon target text in documents associated with the applications.

5. The method of claim 1, further comprising enabling client applications to download the usage database over a network to local storage of a computing device to perform usage checks upon target text in documents associated with the applications.

6. The method of claim 1, wherein searching the documents available from the usage sources comprises performing a web-based search of multiple web domains designated as the usage sources.

7. The method of claim 1, wherein the usage database is built as a source of correct usage phrases extracted from usage sources that are selected as examples of correct usage.

8. The method of claim 1, wherein the usage database is built as a global database that spans multiple languages, styles, and contexts.

9. The method of claim 1, wherein parsing the documents to derive usage phrases representative of correct usage comprises processing the documents sentence-by-sentence.

10. The method of claim 1, wherein parsing the documents to derive usage phrases representative of correct usage includes recognizing and extracting phrases and sub-phrases contained in the documents by:
separating sentences in each document into constituent phrases;
eliminating designated topical terms from the constituent phrases to derive corresponding usage phrases; and
ascertaining sub-phrase combinations of terms contained within the usage phrases.

11. The method of claim 10, wherein building the usage database comprises adding instances of the derived usage phrases and ascertained sub-phrase combinations into the usage database as correct usage phrases.

12. The method of claim 11, further comprising:
collecting metadata that is indicative of contextual usage of the correct usage phrases; and
storing the metadata in association with the correct usage phrases.

13. The method as described in claim 12, wherein the metadata stored in association with the correct usage phrases enables filtering of the usage database to derive context-specific sub-sets of the correct usage phrases to apply for usage checks in different corresponding contexts.

14. One or more computer-readable storage media comprising instructions stored thereon that, responsive to execution by a computing device, cause the computing device to implement a search-powered usage service configured to perform operations including:
creating a usage database from one or more usage sources selected as examples of correct usage by:
searching documents available from the one or more usage sources;
separating sentences in the documents into constituent phrases;
eliminating designated topical terms from the constituent phrases to derive corresponding usage phrases;
ascertaining sub-phrases contained within the usage phrases; and
adding instances of the derived usage phrases and ascertained sub-phrases into the usage database as correct usage phrases; and
exposing the usage database having the correct usage phrases via a network-accessible service to enable applications to analyze target text by comparing phrases in the target text to correct usage phrases contained in the usage database and perform responsive actions to facilitate correct usage.

15. One or more computer-readable storage media as described in claim 14, wherein creating the usage database further includes associating metadata that is indicative of contextual usage of the correct usage phrases with the correct usage phrases.

16. One or more computer-readable storage media as described in claim 15, wherein the search-powered usage service is further configured to perform operations for filtering of the usage database based on the metadata for a particular context to derive a context-specific version of the database to apply for usage checks upon target text that match the particular context.

17. A computing device comprising:
a processing system;
one or more computer readable media storing instructions executable via the processing system to cause the computing device to perform operations comprising:
detecting invocation of a usage checker to check target text of a document associated with a particular context;
identifying a search-powered usage database that is a source of correct usage phrases and matches the particular context;
separating the target text into constituent phrases;
analyzing each of the constituent phrases to recognize correct usage and detect incorrect usage by comparing the constituent phrases to the correct usage phrases contained in the identified search-powered usage database; and
performing one or more actions based on the analyzing to facilitate correct usage.

18. The computing device as described in claim 17, wherein the one or more actions to facilitate correct usage comprise outputting indications to represent distinctions between correctly used phrases and incorrectly used phrases including one or more of indications to notify a user regarding correct usage or indications to notify a user regarding incorrect usage.

19. The computing device as described in claim 17, wherein the one or more actions to facilitate correct usage comprise providing functionality to perform corrections of usage including one or more of functionality for auto-correction of incorrect usage or functionality for generating and offering correction candidates for incorrect usage.

20. The computing device as described in claim 17, wherein the one or more actions to facilitate correct usage comprise rendering visual indicators in a user interface in which the target text is displayed, wherein:
the visual indicators are configured to provide visual cues to a user regarding correct usage and incorrect usage as determined by the analyzing; and
the visual indicators are selectable to expose metadata for a corresponding phrases in the target text within the user interface.
